(19) United States
(12) Patent Application Publication
(10) Pub. No.: US 2026/0287966 A1
(43) Pub. Date: Sep. 24, 2026

(54) Switchable Optical Light Source and Light Switching Unit

(71) Applicant: Universiteit Twente, Enschede (NL)

(72) Inventors: Yvan Klaver, Enschede (NL); David Albert Immanuel Marpaung, Enschede (NL)

(21) Appl. No.: 19/472,537

(22) PCT Filed: Mar. 8, 2024
(86) PCT No.: PCT/NL2024/050115

§ 371 Date: Oct. 3, 2025

(30) Foreign Application Priority Data
Apr. 6, 2023 (NL) 2034518

(51) Int. Cl. G02F 1/21; G02F 1/225

(52) U.S. Cl. CPC G02F 1/213; G02F 1/2255; G02F 2203/15; G02F 2203/56

(57) ABSTRACT

The present application concerns a switchable optical light source comprising a coherent light source and a light switching unit, configured to receive coherent light from the coherent light source. The light switching unit comprises a first optical resonator into which the coherent light is optically coupled, and a second optical resonator optically coupled to the first optical resonator. The first and second optical resonators are both Kerr active and Brillouin active. By changing the coupling factor corresponding to the optical coupling between the first and second optical resonators, and at least one of (A) an optical path length of at least one of the first and second optical resonators and (B) a frequency of the coherent light, the switchable optical light source can be switched between operating in a first operational state, in which the switchable optical light source functions as a Kerr frequency comb generator and a second operational state, in which the switchable optical light source functions as a Brillouin laser.

The present invention relates to a switchable optical light source. More in particular, the present invention relates to a switchable optical light source that is capable of switching between a first operational state in which the switchable optical light source functions as a Kerr frequency comb generator, and a second operational state in which the switchable optical light source functions as a Brillouin laser. Furthermore, the present invention is related to a light switching unit configured for receiving coherent light from a coherent light source and configured to output either a Kerr frequency comb or Brillouin laser light.

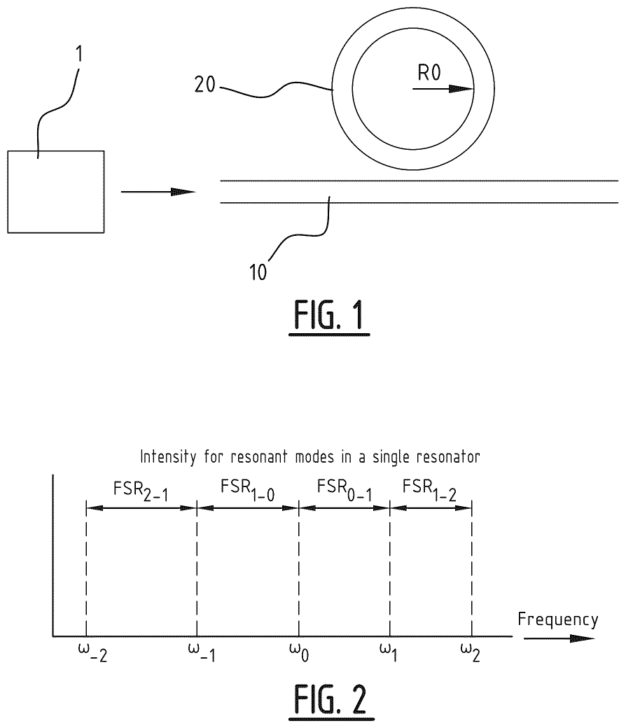

Optical resonators are known in the art. An example of an optical resonator is an optical ring resonator as shown in FIG. 1. Here, a light source 1, such as a continuous wave, CW, laser, outputs coherent light into a bus waveguide 10. The bus waveguide 10 is optically coupled to a ring-resonator 20. Light that propagates through bus waveguide 10 couples into ring-resonator 20. There, it may add up constructively to build up energy inside ring-resonator 20 provided that the wavelength of the light that propagates through ring-resonator 20 complies with:

$$m λ = 2 π {R}_{0} \qquad ( 1 )$$

wherein λ is the wavelength, m an integer larger than 0, and R₀ the radius of ring-resonator 20. Equation 1 can be re-written as:

$$ω = 2 π f = \frac{2 π c}{{n}_{eff} λ} = \frac{2 π c m}{{n}_{eff} 2 π {R}_{0}} = \frac{c m}{{n}_{eff} {R}_{0}} \qquad ( 2 )$$

wherein n_{eff} is the effective refractive index, and f the frequency of the light. The separation in space between two adjacent frequencies at which resonance is possible is referred to as the free spectral range, FSR, and can be found using:

$$F S R = \frac{c}{{n}_{g} 2 π {R}_{0}} \qquad ( 3 )$$

wherein n_{g} is the group velocity refractive index.

The material of optical resonators is generally dispersive. This means that the refractive index is wavelength dependent. Most often, the refractive index increases with increasing frequency, at least in the frequencies of interest. According to equation 3, this means that the spacing between adjacent resonance frequencies decreases with increasing frequencies. This is shown in FIG. 2 and is described in equation 4.

$$( … ) > {FSR}_{2 - 1} > F S {R}_{1 - 0} > F S {R}_{0 - 1} > F S {R}_{1 - 2} > ( … ) \qquad ( 4 )$$

Light sources that generate a Kerr frequency comb and light sources that generate Brillouin laser light are known from the art.

Generating a Kerr frequency comb requires material that is Kerr active. This means that the refractive index of the material depends on the intensity of the light that propagates through it. It is known that in this non-linear material, two photons of identical energies may interact to thereby produce two photons that have different energies. This process is referred to as degenerate four-wave mixing. Additionally, two photons of different energies may interact to thereby produce two photons that also have different energies. This process is referred to as non-degenerate four-wave mixing. These two mixing processes are examples of the so-called Kerr effect.

Applied to FIG. 1, when light first couples into ring-resonator 20 from bus waveguide 10, only light with a single frequency propagates through ring-resonator 20. This frequency must coincide with a resonance frequency of ring-resonator 20 to allow sufficient energy build-up. Since there is, initially, only this single frequency, as a first step, degenerate four-wave mixing will occur provided that the energy of the light in ring-resonator 20 exceeds a given threshold.

In order for sufficient energy build-up inside ring-resonator 20, two conditions must be complied with. The first condition is that the sum of energies of the generated photons corresponds to the sum of energies of the original photons. The second condition is that the frequencies corresponding to the original photons and those of the generated photons each correspond to a respective resonance frequency inside ring-resonator 20.

Ideally, the abovementioned Kerr-effect results in the construction of a so-called Kerr frequency comb having a plurality of equidistant peaks, generally decreasing in frequency the farther away one peak is from the original frequency. Light inside ring-resonator 20 having this frequency characteristic may couple back into bus waveguide 10, via which it may be outputted.

However, these requirements are difficult to comply with due to the earlier discussed dispersion in optical resonators.

Generating a Brillouin laser requires material that is Brillouin active. This means that the material can both provide (A) strong coupling between the optical and acoustical fields, either via electro-strictive forces or other electro-mechanical coupling effects and provide (B) a strong overlap of the acoustic and optical field profile for the propagating fields and a long lifetime for these propagating waves.

In Brillouin scattering, a photon will interact with a phonon that travels through the same material. The phonon may be introduced purposely using a probe or seed signal or the process may ‘self-start,’ relying on the presence of noise, e.g. (thermal) phonons. More in particular, the original photon can interact inelastically with the original phonon, thereby generating a new photon that has a lower frequency than the original photon, the so-called Stokes process, and an additional phonon with properties similar to the original phonon. The original photon is consumed in the process but the original phonon is not. Now having two phonons, the abovementioned Stokes process becomes more likely to occur, i.e. is stimulated. This scattering process results in the accumulation of optical energy in an optical resonator if the frequencies of both the original photon and that of the generated photon coincide with a resonance frequency of said optical resonator.

The difference in energy between the original photon and the newly generated photon is relatively small. An optical resonator that supports the necessary resonance frequencies because the FSR is sufficiently small, will, as follows from equation 3, also require a large radius. This makes such resonators generally unwieldy.

US 2021/373362A1 discloses, according to its abstract, optical frequency combs and related methods, devices, and systems. An example device can comprise a waveguide configured to optically couple to an optical source and at least one optical resonator optically coupled to the waveguide. The one or more of the at least one optical resonator can be tuned such that an optical frequency comb is generated based on mode interaction between two different modes of the at least one optical resonator. The device can comprise an output coupled to the waveguide and configured to output the optical frequency comb.

A switchable light source is also described in the paper by Xue XiaoXiao et al entitled “Super-efficient temporal solitons in mutually coupled optical cavities”, Nature photonics, nature publishing group UK, London, part 13, no. 9, 2019 May 13, pp. 616-622.

It is an object of the present invention to provide a switchable optical light source that allows for switching between functioning as a Kerr frequency comb generator and functioning as a Brillouin laser.

This object is achieved using a light source as defined in claim 1 that comprises a coherent light source and a light switching unit, configured to receive coherent light from the coherent light source. The light switching unit comprises a first and a second optical resonator. The coherent light is optically coupled into the first optical resonator. The second optical resonator is optically coupled to the first optical resonator. The first and second optical resonators are both Kerr active and Brillouin active. By changing the coupling factor corresponding to the optical coupling between the first and second optical resonators, and at least one of (A) an optical path length of at least one of the first and second optical resonators and (B) a frequency of the coherent light, the switchable optical light source can be switched between operating in a first operational state, in which the switchable optical light source functions as a Kerr frequency comb generator, and a second operational state, in which the switchable optical light source functions as a Brillouin laser.

Preferably, the first and second optical resonators, would they be considered in isolation, both support a first resonance frequency and, optically coupled to each other, both support two split resonance frequencies corresponding to said first resonance frequency. Either one or both of these split resonance frequencies may be used in pairs or trios of resonance frequencies necessary for switching the operational states.

In some embodiments, switching the switchable optical light source to the first operational state comprises changing the coupling factor and the frequency of the coherent light such that the first and/or the second optical resonator(s) support a trio of equidistant resonance frequencies, including either of the two split resonance frequencies, and of which a middle resonance frequency is substantially equal to the frequency of the coherent light.

Specifically, changing the coupling factor and the frequency of the coherent light may comprise changing the coupling factor such that a distance between the higher of the two split resonance frequencies and a second resonance frequency is substantially equal to a distance between the second resonance frequency and a third resonance frequency, wherein the second and third resonance frequencies are either both lower or both higher than the two split resonance frequencies, and changing the frequency of the coherent light to be substantially equal to the second resonance frequency. Alternatively, changing the coupling factor and the frequency of the coherent light may comprise changing the coupling factor such that a distance between the lower of the two split resonance frequencies, and a second resonance frequency, lower than the two split resonance frequencies, is substantially equal to a distance between the lower of the two split resonance frequencies and a third resonance frequency, higher than the two split resonance frequencies, and changing the frequency of the coherent light to be substantially equal to the lower of the two split resonance frequencies.

In other embodiments, switching the switchable optical light source to the first operational state comprises changing the coupling factor and the optical path length of at least one of the first and second optical resonators, such that the first and/or second optical resonator(s) support a trio of equidistant resonance frequencies, including either of the two split resonance frequencies, and of which a middle resonance frequency is substantially equal to the frequency of the coherent light.

Specifically, changing the coupling factor and the optical path length of at least one of the first and second optical resonators may comprise changing the coupling factor such that a distance between the higher of the two split resonance frequencies and a second resonance frequency is substantially equal to a distance between the second resonance frequency and a third resonance frequency wherein the second and third resonance frequencies are either both lower or both higher than the two split resonance frequencies, and changing the optical path length of the first and second optical resonators such that the second resonance frequency is substantially equal to the frequency of the coherent light. Alternatively, changing the coupling factor and the optical path length of at least one of the first and second optical resonators may comprise changing the coupling factor such that a distance between the lower of the two split resonance frequencies, and a second resonance frequency, lower than the two split resonance frequencies, is substantially equal to a distance between the lower of the two split resonance frequencies and a third resonance frequency, higher than the two split resonance frequencies, and changing the optical path length of the first and second optical resonators such that the lower of the two split resonance frequencies is substantially equal to the frequency of the coherent light.

Switching to the second operational state may be achieved by changing the coupling factor such that a distance between the two split resonance frequencies is equal to a desired frequency shift, changing the frequency of the coherent light to be substantially equal to the higher of the two split resonance frequencies, and, optionally, coupling further coherent light into the first or the second optical resonator having a frequency equal to the lower of the two split resonance frequencies.

Alternatively, switching to the second operational state comprises changing the coupling factor such that a distance between the two split resonance frequencies is equal to a desired frequency shift, changing the optical path length of the first and the second optical resonators such that the higher of the two split resonance frequencies is substantially equal to the frequency of the coherent light, and, optionally, coupling further coherent light into the first or the second optical resonator having a frequency equal to the lower of the two split resonance frequencies.

In some embodiments, to be able to change the coupling factor, the light switching unit further comprising a tuneable coupler, optically coupling the first and second optical resonators, and a controller configured to change said coupling factor by tuning the tuneable coupler.

In some embodiments, the light switching unit further comprising a first light guiding element that is configured to receive the coherent light, and that is optically coupled to the first optical resonator. Preferably, the first light guiding element is a waveguide.

In some embodiments, the light switching unit further comprising a second light guiding element, optically coupled to the first or second optical resonator and configured to guide at least one of the generated Kerr-frequency comb or the generated Brillouin laser light, preferably both. Preferably, the second light guiding element is a waveguide.

For spatial efficiency, in some embodiments, the first and second light guiding elements are the same light guiding element. Considering the preferred embodiments, the first and second waveguides may be the same waveguide.

There are various manners that the optical resonators may be implemented.

In some embodiments, the first and the second optical resonators are integrated optical waveguides. Specifically, the first and the second optical resonators may be one of: symmetric double stripe silicon nitride waveguides, chalcogenide waveguides, silicon oxynitride waveguides, Tellurite waveguides, or suspended silicon ridge waveguides. Specifically, the first and second optical resonators may be optical ring resonators, such as micro-ring resonators (MRR) or two-dimensional photonic crystal-based ring resonators.

There are also various manners that the tuneable coupler may be implemented. In some embodiments, the tuneable coupler is implemented as a pully coupler, a straight-directional coupler, or via a multi-mode interferometer (MMI) coupler, a MEMS activated coupler, a Mach-Zhender coupling structure, or a directional coupler.

In an alternative embodiment, the first and the second optical resonators are whispering gallery mode (WGM) resonators, preferably one of toroid, microsphere, WGM carved in crystal rod, or disk micro-resonators. In an alternative embodiment, wherein the first and the second optical resonators are Fabry-Perot (FP) cavity resonators, preferably Bragg-grating confined FP resonators or highly reflecting coated waveguide FP resonators.

The present disclosure further provides for a light switching unit according to any of the abovementioned embodiments.

Next, the present invention is explained in more detail by referring to the appended figures, wherein similar or identical components are referred to using the same reference signs, and wherein:

FIG. 1 shows a light source known from the art and FIG. 2 shows, on a frequency spectrum, at which frequencies light can resonate in the optical resonator of said light source.

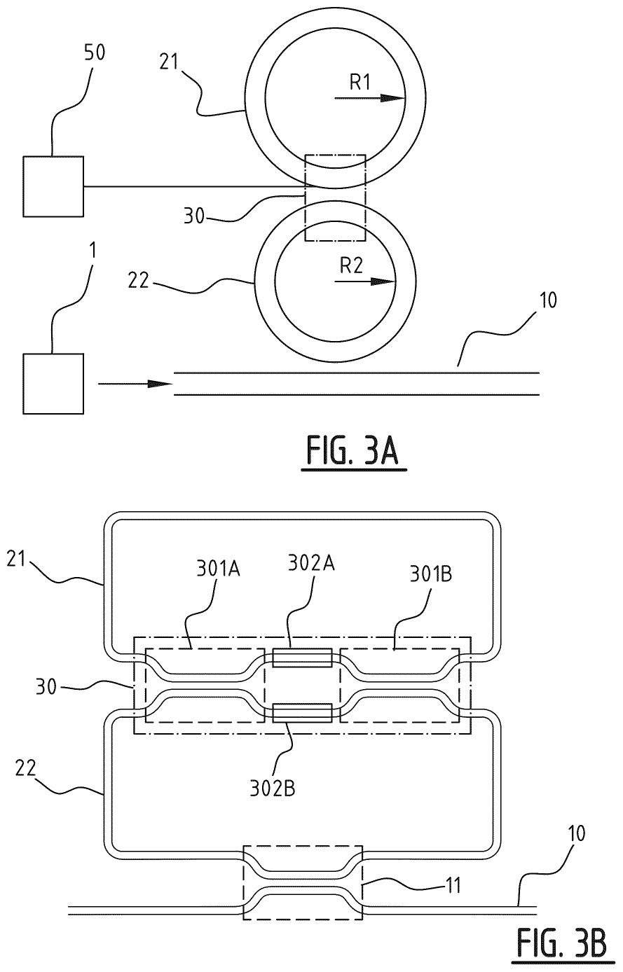

FIG. 3A shows an embodiment of a switchable optical light source according to the invention and FIG. 3B shows an embodiment of a light switching unit according to the invention;

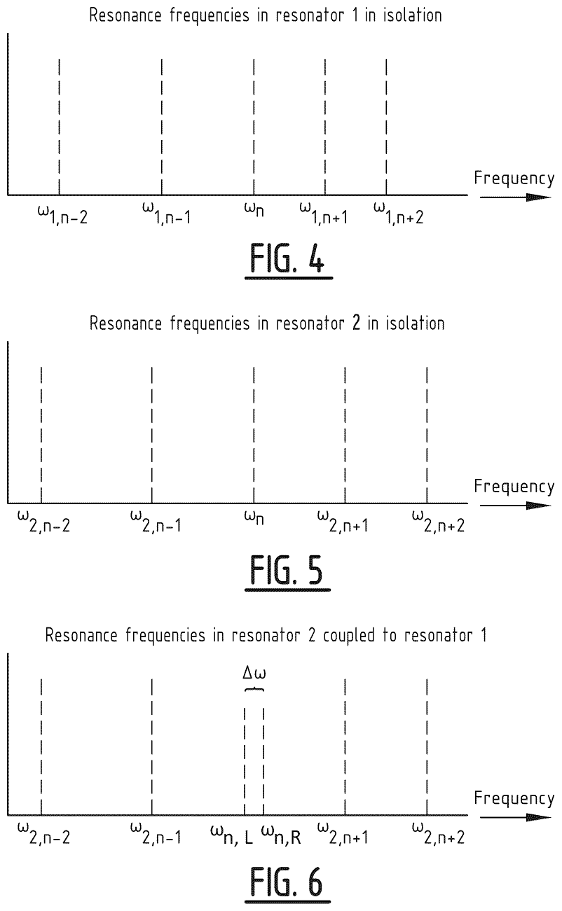

FIGS. 4 and 5 show, on a frequency spectrum, at which frequencies light can resonate in the ring resonators shown in FIG. 3.

FIG. 6 shows, on a frequency spectrum, at which frequencies light can resonate in one of the ring-resonators of FIG. 3 when optically coupled to the other ring-resonator;

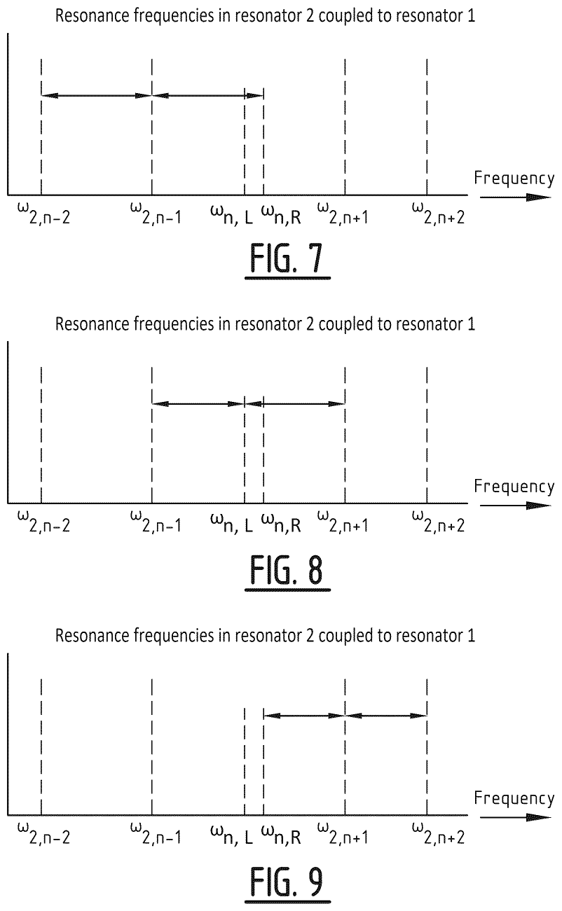

FIGS. 7, 8, and 9 show, on a frequency spectrum, trios of equidistant frequencies that can be formed by changing a coupling factor op the optical coupling between the ring-resonators shown in FIG. 3.

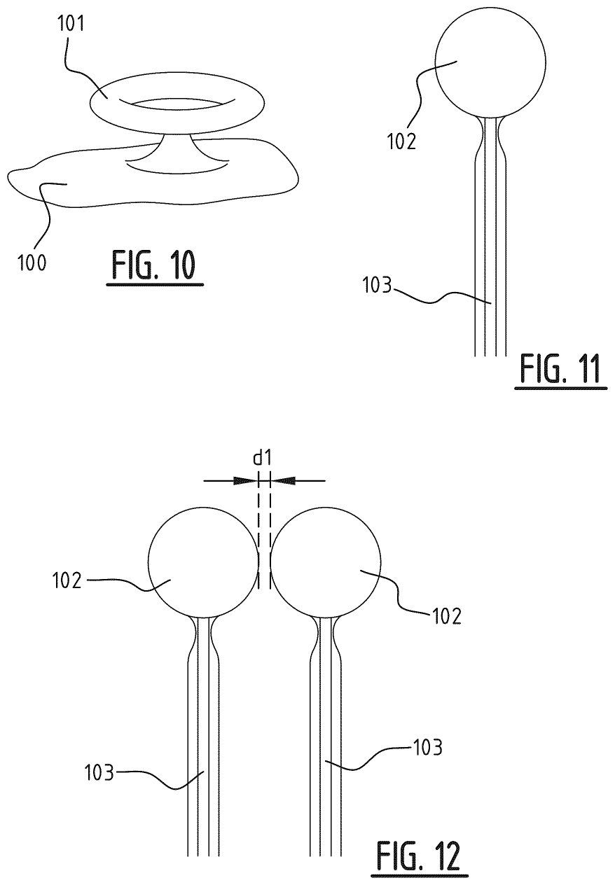

FIGS. 10-14 show various optical resonators;

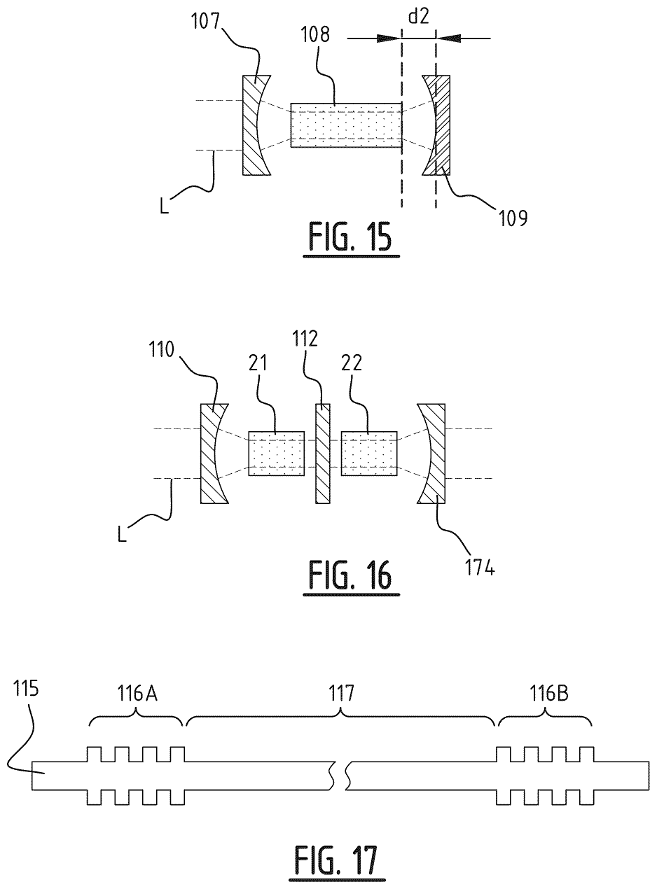

FIGS. 15 and 16 show embodiments of light switching units according to the invention based on Fabry-Perot resonators;

FIGS. 17-21 shows various optical resonators;

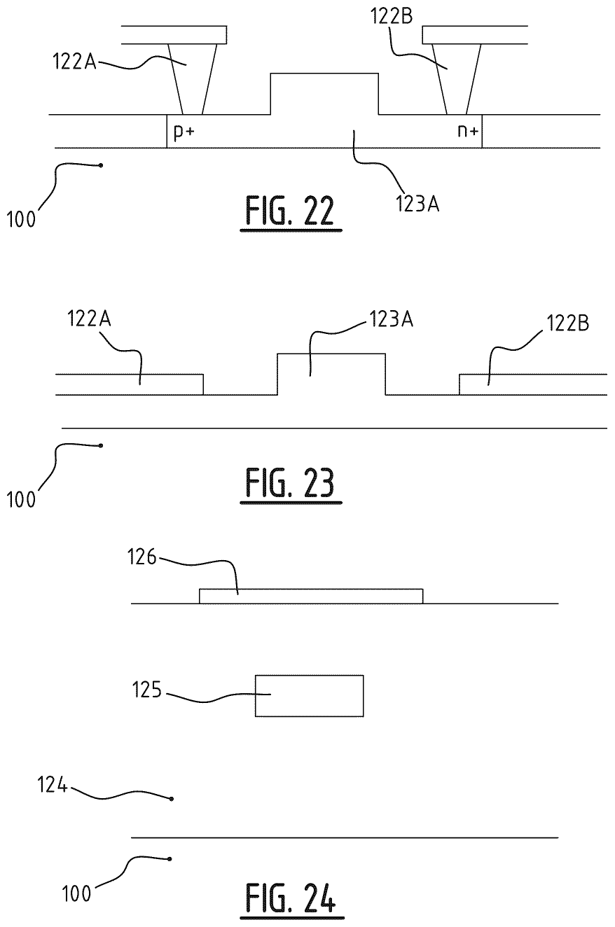

FIGS. 22-26 show various means for changing the optical path length in a waveguide;

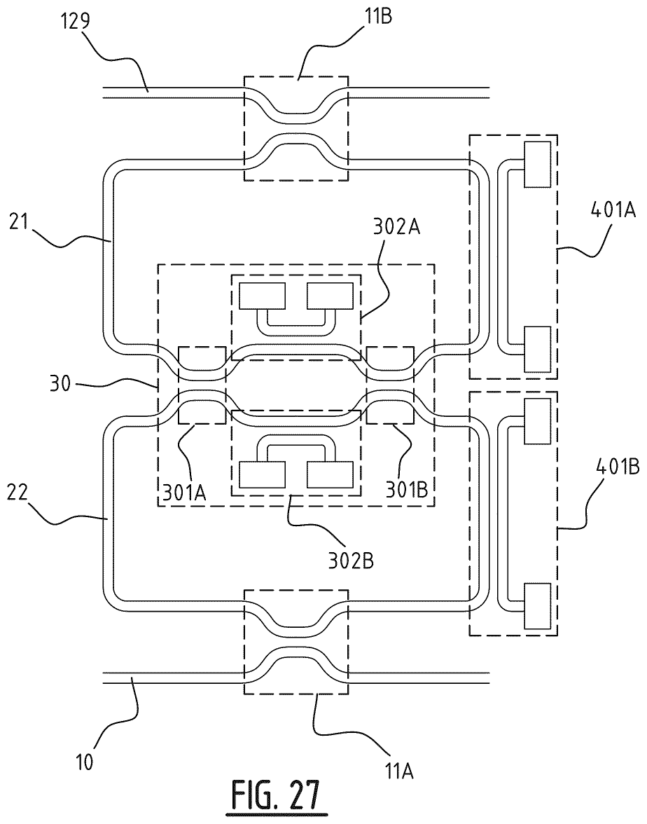

FIG. 27 shows an embodiment of a light switching unit according to the invention;

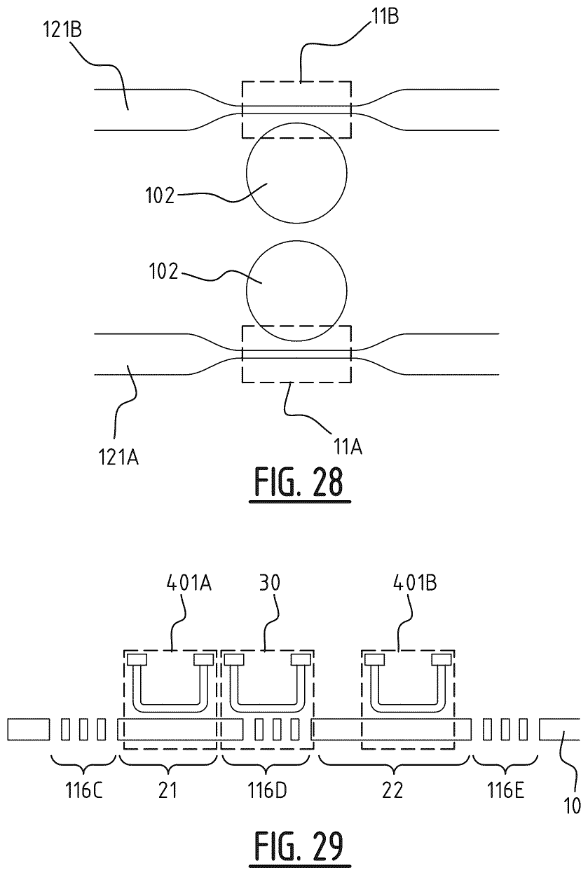

FIG. 28 shows an embodiment of a light switching unit according to the invention;

FIG. 29 shows an embodiment of a light switching unit according to the invention;

FIG. 3A shows an embodiment of a switchable optical light source is shown in FIG. 2, including a coherent light source 1 and bus waveguide 10. Further shown is ring-resonator 22, optically coupled to bus waveguide 10 and ring-resonator 21, in turn coupled to ring-resonator 22. In the embodiment shown, the ring-resonators are optically coupled using adjustable optical coupler 30 and a controller 50 is provided, configured to control the tuneable coupler.

The skilled person will appreciate that a resonator having or supporting a certain resonance frequency, means that light at that frequency can resonate inside of said resonator. The skilled person will further appreciate that the coupling strength and coupling factor between two light guiding elements may be used synonymously.

The resonance frequencies for ring-resonators 21 and 22 when considered in isolation are shown in FIGS. 4 and 5, respectively. In this embodiment, a radius R1 of ring resonator 21 is larger than a radius R2 of ring resonator 22, resulting ring-resonator 21 having smaller spectral ranges than ring resonator 22, as shown in FIGS. 4 and 5. Ring resonators 21 and 22 share a resonance frequency ωₙ, causing mode splitting to occur. Mode splitting, in this context, means that instead of the one resonance frequency ωₙ, light resonate in the combination of ring-resonators 21, 22 in two split resonance frequencies ω_{2,n,L} and ω_{2,n,R}, also referred to as hybrid modes. This is shown in FIG. 6, in the context of the resonance frequencies for ring resonator 22. Specifically, FIG. 6 indicates the resonance frequencies for light propagating in ring-resonator 22 when optically coupled to ring-resonator 21.

In this embodiment, light from coherent light source 1 may be coupled into ring-resonator 22 via bus waveguide 10. The skilled person will appreciate that other light guiding elements may also be used to couple light into ring-resonator 22, as long as they can receive the coherent light and be optically coupled to the ring-resonator 22.

In this embodiment, light may also exit ring-resonator 22 via bus waveguide 10. There are also embodiments conceivable in which this is achieved via a second light guiding element. One light guiding element for guiding the Kerr-frequency comb and one light guiding element for guiding the Brillouin laser is to be provided. This may be one and the same element. Provided may be, for example, a separate bus waveguide, coupled to either of the ring-resonators 21-22 and configured to guide at least one of the generated Kerr-frequency comb or the generated Brillouin laser light. Ideally both.

Controller 50 is configured to change the coupling factor of tuneable coupler 30. The skilled person will appreciate that the coupling factor is a metric for describing the amount of light that is exchanged between ring-resonators 21 and 22. Changing the coupling factor changes the two split resonance frequencies ω_{n,L} and ω_{n,R}, and/or changes the distance Aw between said split resonance frequencies. It may be generally said that increasing the coupling factor increases the distance between the two split resonance frequencies.

The skilled person will be aware that Brillouin lasers can be generated using a purposely introduced probe signal (also sometimes referred to as a seed signal) but also by relying on noise, such as thermal phonons. Both such a probe signal and noise can be used to achieve stimulated Brillouin scattering. Embodiments are conceivable in which the coherent light source is further configured to provide such a probe signal. Embodiments are also conceivable in which the switchable optical light source comprises a further coherent light source configured to provide such a probe signal. Embodiments are also conceivable in which no probe signal is purposely provided. In such embodiments, the switchable optical light source may also be considered a self-starting oscillator.

In FIG. 3A, ring resonators 21 and 22, tuneable coupler 30 and bus waveguide 10 form a light switching unit. Such unit may be provided as a photonics integrated system. In FIG. 3B, another embodiment of a light switching unit according to the invention is shown. Said embodiment comprises, again, resonators 21 and 22, tuneable coupler 30 and bus waveguide 10. In this embodiment in particular, bus waveguide 10 and resonator 22 are coupled via coupler 11.

Tuneable coupler 30 comprises two static couplers 301A and 301B, both of which optically couple resonators 21 and 22, and two means for changing the optical path length 302A and 302B, which are arranged to heat a portion of resonators 21 and 22, respectively. The skilled person will appreciate that the tuneable coupler 30 shown in FIG. 3B is also known as a balanced Mach-Zehnder interferometer.

Ideally, static couplers 301A and 301B both have a coupling factor of 50% and the portions of resonators 21 and 22 of which the optical path lengths can be changed by means 302A and 302B are equally long—also referred to as balanced. Changing the optical path length of one of the portions of resonator 21 or 22 causes a phase shift in light traveling through this heated portion, with respect to light traveling through the non-heated portion. The skilled person will appreciate that tuneable coupler 30 may also be provided with just one light guide heater arranged to heat a portion of either of resonator 21 or resonator 22.

The switchable optical light source as shown in FIG. 3A (or the light switching unit in FIG. 3B in collaboration with a coherent light source) can be switched between two operating modes by adjusting the coupling factor. At the appropriate coupling factor, a trio of equidistant resonance frequencies can be formed to support the photons generated by the earlier discussed four-wave mixing process, thereby allowing the generation of a Kerr frequency comb.

Also, at the appropriate coupling factor, the distance between the split frequencies is may corresponds to a difference between an original photon and a photon created by Brillouin scattering. Alternatively said, both the original photon frequency and the created photon frequency then each correspond to either of the two split resonance frequencies, allowing for energy to be built up inside ring-resonators 21 and 22. That is, the distance Aw may correspond to a frequency shift necessary for generating a Brillouin laser, in the art also occasionally referred to as the Stokes frequency shift.

How various embodiments of the switchable optical light source can be operated in the two operating modes is further elucidated in the following examples. The skilled person will appreciate that one frequency being ‘above’ another is synonymous to said frequency being higher than the other, and that one frequency being ‘below’ another is synonymous to said frequency being lower than the other. While the following examples have enumerated steps, the skilled person will appreciate that the steps do not necessarily have to be performed in the order mentioned here. Additionally, goals achieved here by separate steps may, in other embodiments, be achieved in a single step. And goals achieved here in a single step may, in other embodiments, be achieved in separate steps.

### EXAMPLE 1

In some embodiment, the switchable optical light source can be switched between operating in the two operating modes by changing the coupling factor for the optical coupling between ring-resonators 21 and 22, and the frequency of the coherent light source.

In such embodiments, ring-resonators 21 and 22 support, when isolated, a resonance frequency ωₙ, and, when optically coupled to each other, split resonance frequencies ω_{n,L} and ω_{n,R}. These split resonance frequencies may be calculated as:

$${ω}_{n , L} = {ω}_{n} - \frac{1}{2} Δω$$

$${ω}_{n , R} = {ω}_{n} + \frac{1}{2} Δω$$

In some of such embodiments, the optical path lengths for ring-resonators 21 and 22 may be constant and the above requirements would always be fulfilled. In other embodiments, the optical path length of the ring-resonators 21 and 22 may have to be adjustable to achieve the mentioned mode splitting.

This Embodiment May be Operated Such that it Generates a Kerr Frequency Comb by:

Step 1-A: Adjusting the coupling factor, thereby changing Δω and forming a trio of equidistant frequencies. Possible trios that can be formed this way are shown in FIGS. 7, 8, and 9. In FIG. 7, a trio of equidistant frequencies is formed by two resonance frequencies of ring-resonator 22 below the split frequencies, and the higher of the two split frequencies. In FIG. 8, a trio of equidistant frequencies is formed by one resonance frequency of ring-resonator 22 below the split frequencies, the lower of the two split frequencies, and one resonance frequency of the ring-resonator 22 higher than the split frequencies. In FIG. 9, a trio of equidistant frequencies is formed by the higher of the two split frequencies and two resonance frequencies of the ring-resonator 22 higher than the split frequencies.

While in FIGS. 7 and 9, the two resonance frequencies lower of higher than the shared resonance frequency are specifically pairs of resonance frequencies directly above or below (e.g. adjacent pairs of resonances frequencies, i.e. those indexed [n−2, n−1] or [n+1, n+2]), the skilled person will appreciate that other pairs above or below the shared resonance frequency may also be used. It is also possible to form a trio of equidistant resonance frequencies with the higher of the two split frequencies using pairs of resonance frequencies father therefrom (e.g. those indexed [n−4, n−2], or [n+2, n+4]).

While in FIG. 8, the resonance frequency higher and the resonance frequency lower than the shared resonance frequency are specifically a pair of resonance frequencies of one directly above and one directly below (e.g. pairs indexed [n−1, n+1]), the skilled person will appreciate that other pairs above and below the shared resonance frequency may also be used. It is also possible to form a trio of equidistance resonance frequencies with the lower of the two split frequencies using pairs of resonances frequencies farther therefrom (e.g. those indexed [n−2, n+2] or [n−3, n+3]).

Step 1-B: Adjusting the frequency of the coherent light source (1) to equal the middle frequency of the formed trio of equidistant frequencies. In the trio shown in FIG. 7, this would be ω_{2,n-1}. In the trio shown in FIG. 8, this would be ω_{2,L}. In the trio shown in FIG. 9, this would be ω_{2,n+1}.

This Embodiment May be Operated Such that it Generates a Brillouin Laser by:

Step 1-C: Adjusting the coupling factor, thereby changing Δω such that it corresponds to the stokes frequency shift.

Step 1-D: Adjusting the frequency of the coherent light source (1) to equal the higher of the two split frequencies, and, either: providing a probe signal at the other of the two split frequencies or, relying on noise and/or thermal phonons, allowing the switchable optical light source to self-start.

### EXAMPLE 2

In some embodiment, the switchable optical light source can be switched between operating in the two operating modes by changing the coupling factor for the optical coupling between ring-resonators 21 and 22, and the optical path lengths of both ring-resonator 21 and ring-resonator 22. In such embodiments, the frequency of coherent light source 1 may be constant.

This Embodiment May be Operated Such that it Generates a Kerr Frequency Comb by:

Step 2-A: Adjusting the optical path length of ring-resonator 22 such that one the frequency of the coherent light source corresponds to a resonance frequency of ring-resonator 22 (e.g. ω_{2,n-1} or ω_{2,n-1}) and adjusting the optical path length of ring-resonator 21 such that ring-resonators 21 and 22 share a resonance frequency adjacent thereto (e.g. ωₙ), resulting in both ring-resonators 21 and 22 supporting two split resonance frequencies ω_{n,L} and ω_{n,R}.

Step 2-B: Adjusting the coupling factor, thereby changing Δω and forming a trio of equidistant frequencies with the higher of the two split frequencies, the frequency of the coherent light source 1, and a resonance frequency of ring-resonator 22 on a side of the frequency of the coherent light source 1, opposite to the side of the higher of the two split frequencies. Possibles trios are shown in FIGS. 7 and 9 and discussed under example 1.

This Embodiment May Also be Operated Such that it Generates a Kerr Frequency Comb by:

Step 2-C: Adjusting the optical path length of ring-resonators 21 and 22 such that they support, when isolated, a resonance frequency ωₙ and, when optically coupled to each other, support split frequencies ω_{n,L} and ω_{n,R}.

Step 2-D: Adjusting the coupling factor, thereby changing Δω and forming a trio of equidistant frequencies with the lower of the two split frequencies, and a pair of frequencies, one lower and one higher than the split frequencies. A possible trio is shown in FIG. 8 and discussed under example 1.

Step 2-E: If necessary, adjust the optical path length of ring-resonators 21 and 22 such that the lower of the two split frequencies corresponds to the frequency of coherent light.

This Embodiment May be Operated Such that it Generates a Brillouin Laser by:

Step 2-F: Adjusting the optical path length of ring-resonators 21 and 22 such that they support, when isolated, a resonance frequency ωₙ and, when optically coupled to each other, support split frequencies ω_{n,L} and ω_{n,R}.

Step 2-G: Adjusting the coupling factor, thereby changing Δω such that it corresponds to the stokes frequency shift.

Step 2-H: If necessary, adjust, the optical path lengths of ring-resonators 21 and 22 such that the higher of the two split frequencies corresponds to the frequency of the coherent light source, and providing a probe signal at the other of the two split frequencies.

### IMPLEMENTATIONS

In the embodiment of FIG. 3A, the first and second optical resonators are implemented by micro-ring resonators, which is a type of integrated optical waveguide. In the embodiment of FIG. 3B, the optical resonators are implemented by race-track resonators, and these are coupled to each other and to waveguide 10 via straight directional couplers. However, the skilled person will appreciate that many (other) implementations are possible.

### Optical Resonators

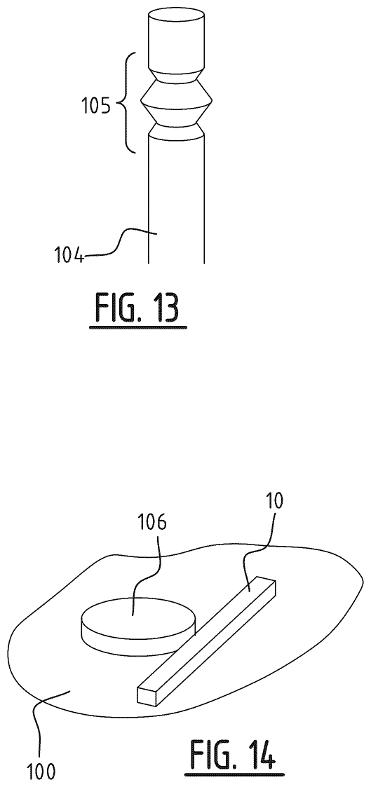

The first and second optical resonators, for example, may be implemented as whispering gallery mode (WGM) resonators. Specifically, the optical resonators may be implemented as a toroid optical resonator 101 arranged on a substrate 100 (see FIG. 10), a microsphere resonator 102 connected via a glass-fibre 103 (see FIG. 11 for one, and FIG. 12 for a pair), a WGM resonators 104 carved into a crystal rod 104 (see FIG. 13), or a micro disk resonator 106 arranged on a substrate 100 (see FIG. 14).

It is also possible for the first and second optical resonators to be implemented as Fabry-Perot (FP) cavity resonators. FIGS. 15 and 16 show embodiments of light switching units according to the invention in which this is in the case.

In FIG. 15, specifically, light switching unit comprises cavity mirrors 107, 109 and a body of non-linear material 108. In a preferred embodiment, cavity mirror 107 has a reflection of less than 100%, allowing for light to be coupled into the optical resonator. The reflection of cavity mirror 109 may be chosen as high as high as possible, preferably around 100%.

Light L may be input directly from the left, onto cavity mirror 107. By passing through cavity mirror 107, light L is focused onto body 108. After passing through body 108, light L falls on and is at least partially, preferably substantially reflected back onto body 108 via cavity mirror 109. Light passes through body 108 again and arrives as cavity mirror 107 again. There, light L is at least partially, preferably substantially reflected back onto body 108. In this embodiment, light is substantially contained by and moves back and forth between the cavity mirrors 107 and 109, allowing for constructive interference, i.e. functioning as an optical resonator. The optical path length of this optical resonator can be changed by changing a distance d2 between body 108 and cavity mirror 109. Light exits on the same side as it enters.

In FIG. 16, the light switching unit comprises cavity mirrors 110 and 174 and optical resonators 21 and 22 here are implemented as is done in FIG. 15, using bodies of non-linear material. Light L may enter from the left and exit from the right or, in opposite direction, enter from the right and exit from the left. Similar to FIG. 16, the cavity mirrors may be said to at least partially contain the light between them, forming the two coupled resonators. In this embodiment, the coupling factor may be changed by changing transparency of tuneable mirror 112.

Although the embodiments of FIGS. 15 and 16 include cavity mirrors, it is also possible to use other reflective components such as mirrors to form the optical resonator.

It is also possible for the first and second optical resonators to be implemented using Bragg-gratings. FIG. 17 shows an optical resonator based on such Bragg-gratings. Specifically, FIG. 17 shows a waveguide 115 provided with two Bragg-gratings 116A, 116B between which a resonator cavity 117 is formed. While the waveguide is drawn in an interrupted manner, this does not mean that waveguide 115 comprises two halves. The skilled person will be aware that this indicates that there may be various lengths of waveguide in between the portions of waveguide 115 drawn here. There may be various lengths of waveguide in between gratings 116A and 166B. For such embodiments, optical couplers that may be provided are direct-input couplers or evanescent couplers such as pulley couplers or straight directional couplers.

It is also possible for the first and second optical resonators to be implemented as 2-D photonic crystal-based ring resonators (see FIG. 19). Such a resonator comprises a crystal body 120 in which a plurality of (through) holes 121 is provided. These holes are arranged to form a pattern, of which the inverse may form a ring resonator pattern 119 and an input waveguide pattern 10B.

In some embodiments, the optical resonators are ‘symmetric double stripe silicon nitride waveguides,’ ‘chalcogenide waveguides,’ ‘silicon oxynitride waveguides,’ ‘Tellurite waveguides,’ or ‘suspended silicon ridge waveguides.’

However, other materials and methods may be used to provide the optical resonators, the combination of which is sometimes referred to as the ‘platform’ in which the optical resonators are provided.

### Optical Couplers

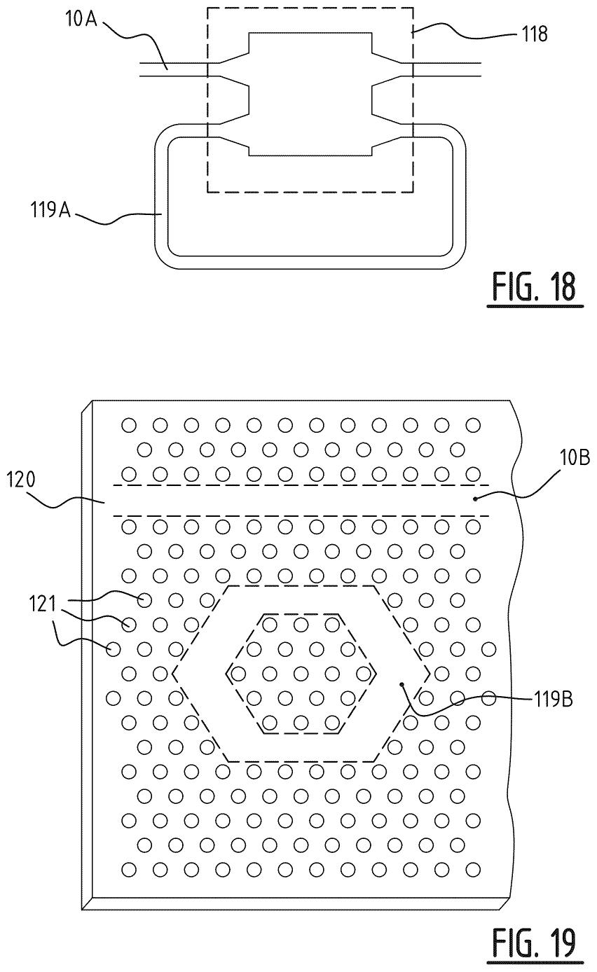

It is possible for the optical couplers to be implemented as the earlier mentioned straight directional couplers, but also pulley couplers, or multi-mode interferometer couplers. See, for an example of an MMI coupler, FIG. 18, which shows a schematic representation of an optical resonator comprising an input waveguide 10A, MMI coupler 118, and racetrack optical resonator 119A. Other possibilities are a MEMS activated coupler, in which physical displacement changes the distance between waveguides, and a directional coupler of adjustable path length.

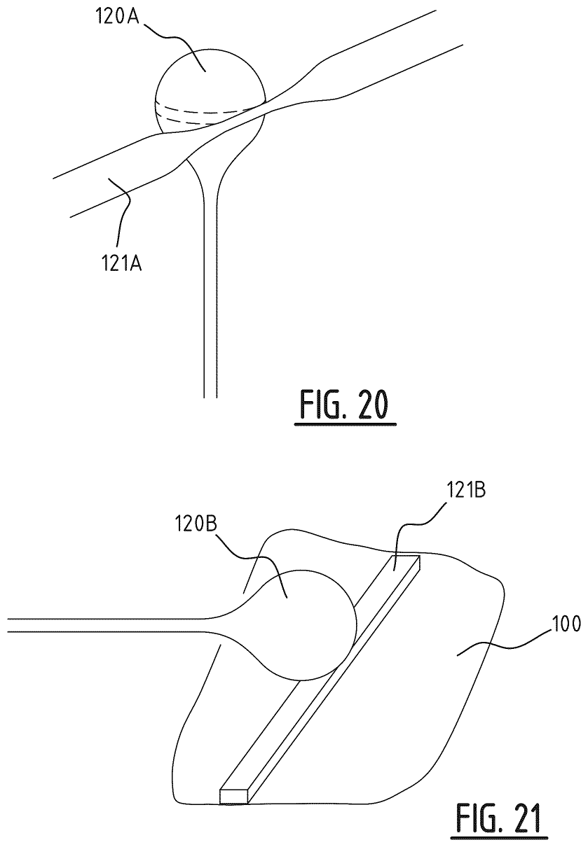

Optical couplers suitable for coupling light into sphere resonators include tapered fibre couplers or evanescent waveguide couplers. In FIG. 20 an example is shown in which tapered fibre 121A is arranged adjacent to sphere resonator 120A, to couple light therein. In FIG. 21 an example is shown in which light is coupled into sphere resonator 120B through an input waveguide 121B arranged on a substrate, relying on evanescent coupling.

A desired overlap between resonance frequencies may be achieved by changing the optical path length of one or both optical resonators. Also, in some tuneable couplers, changing the optical path length is necessary for changing the optical coupling factor. Various implementations are also possible for means for changing the optical path length of (a part of) an optical resonator.

Changing of the optical path length can be achieved by biasing a semiconductor waveguides 123A as exemplified by FIG. 22, arranged on a substrate and comprising an N+ and a P+ side, wherein each of these sides is connected via an electrical contact 122A, 122B.

Changing of the optical path length can also be achieved by biasing a crystal-based waveguides 123B with Pockel's cell effect as exemplified by FIG. 23, arranged on a substrate 100 and to which two electrical contacts are connected 122A, 122B.

Changing of the optical path length can also be achieved by thermo-optical tuning of a waveguide 125 arranged inside a cladding layer 124 as exemplified in FIG. 24, wherein cladding layer 124 is arranged on substrate 100 and wherein an ohmic heating element 126 is provided in cladding layer 124, configured to heat waveguide 125.

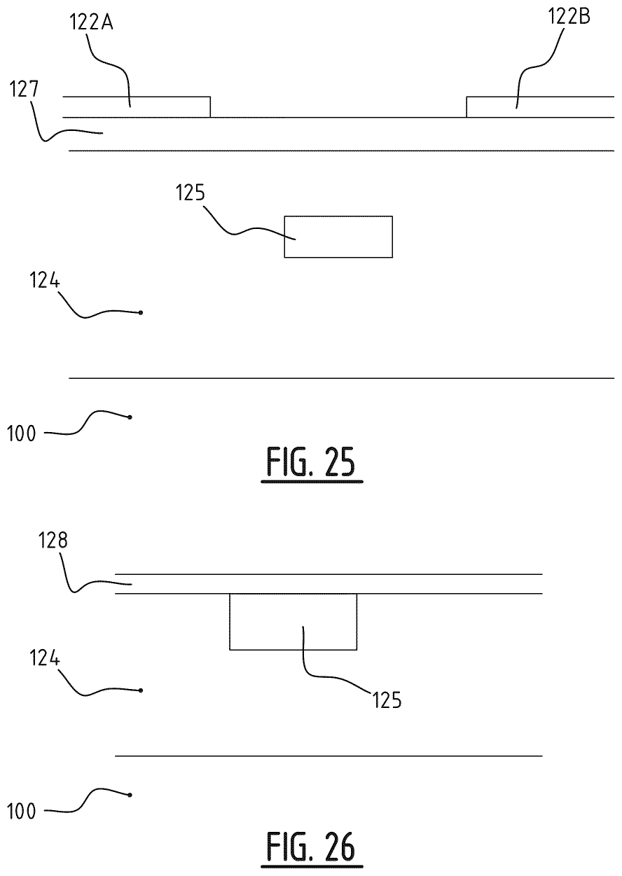

Changing of the optical path length can also be achieved by stress-induced tuning of a waveguide 125 inside a cladding layer 124, as exemplified in FIG. 25, in which a piezo-electric layer 127 is provided on the cladding layer and the cladding layer 124 is provided on substrate 100. To induce stress, piezo-electric layer 127 may be provided with a current through electrical contacts 122A and 122B.

Changing of the optical path length can also be achieved by changing an effective refractive index for a waveguide 125 using phase change material 128 arranged adjacent to waveguide 125 as exemplified in FIG. 26. In such embodiments, waveguide 125 is arranged partially in cladding layer 124 and cladding layer 124 is arranged on substrate 100.

Means for changing a path length, further to the light guide heaters discussed in relation to FIG. 3B, are biased waveguides (for either semiconductor waveguides of electro-optic waveguides), thermo-optic tuning means, stress-inducing tuning means. The phase change required to tune the tuneable coupler may, instead of changing the optical path length, also be provided via phase change material (PCM) which may change effective refractive index.

### FURTHER EXEMPLARY EMBODIMENTS

The skilled person will appreciate that a light switching unit may be provided separately from the coherent light source in an optical light switching unit. According to the invention, a light switching unit may comprise a first optical resonator configured to have coherent light optically coupled therein and a second optical resonator optically coupled to the first optical resonator. The first and second optical resonators are both Kerr active and Brillouin active. The skilled person will be able to derive, given an optical resonator, whether it is Kerr active and/or Brillouin active.

By changing the coupling factor corresponding to the optical coupling between the first and second optical resonators, the light switching unit can be switched between operating in a first operational state, in which the light switching unit functions as a Kerr frequency comb generator and a second operational state, in which the light switching unit functions as a Brillouin laser.

Alternatively phrased, by changing the coupling factor corresponding to the optical coupling between the first and second optical resonators, the light switching unit can be switched between operating in, a first operational state, in which the light switching unit supports degenerative and/or non-degenerative four-wave mixing process, thereby allowing for the generation of a Kerr frequency comb, and a second operational state, in which the light switching unit supports stimulated Brillouin scattering and/or a-stokes process, thereby allowing for the generation of a Brillouin laser.

Shown in FIG. 27 is a further embodiment of a light switching unit according to the invention, comprising a first and second optical resonator 21, 22, each implemented as a race-track resonator. Input waveguide 10 is coupled to second optical resonator 22 via a straight directional coupler 11A and output waveguide 129 is coupled to first optical resonator 21 via a straight directional coupler 11B. The first and second optical resonators are both provided with ohmic heaters 401A and 40B, respectively, arranged to heat at least part of the corresponding optical resonator and thereby adjust the optical path length. The first and second optical resonators are optically coupled to each other via a tuneable coupler 30, which in itself comprises two straight directional couplers 301A, 301B, and ohmic heaters 302A, 30B, arranged to change the optical path length of parts of the first and second optical resonators, respectively.

Shown in FIG. 28 is a further embodiment of a light switching unit according to the invention comprising two microsphere resonators 102, a tapered fibre 121A embodying an input waveguide and optical coupler 11A and a tapered fibre 121B embodying an output waveguide and optical coupler 11B. Coupling factor between fibre 121A and the adjacent microsphere resonator, between the two microsphere resonators, and between fibre 121B and the adjacent microsphere resonator may each be changed by changing the physical distance between the corresponding components.

Shown in FIG. 29 is a further embodiment of a light switching unit according to the invention. Two optical resonators 21, 22 are provided in a linear waveguide by two resonating cavities between, in total, three Bragg-gratings 116C, 116D, and 116E. In this embodiment, the tuneable optical coupler 30 comprises the middle Bragg-grating 116D and an ohmic heater arranged adjacent thereto. Changing the effective optical path length in the Bragg-grating adjusts the coupling factor between the two resonating cavities. Adjacent to each waveguide forming each resonator cavity are provided ohmic heaters as means for adjusting the optical path length in said cavity/optical resonator.

In the above, the present invention has been explained using detailed embodiments thereof. However, the present invention is not limited to these embodiments and other embodiments are possible without deviating from the scope of the present invention, which is defined by the appended claims.

1. A switchable optical light source, comprising:
a coherent light source; and
a light switching unit configured to receive coherent light from the coherent light source, wherein the light switching unit comprises:
a first optical resonator into which the coherent light is optically coupled; and
a second optical resonator that is optically coupled to the first optical resonator,
wherein the first optical resonator and second optical resonator are both Kerr active and Brillouin active,
wherein by changing a coupling factor corresponding to the optical coupling between the first optical resonator and second optical resonator, and by changing at least one of (A) an optical path length of at least one of the first optical resonator and second optical resonator and (B) a frequency of the coherent light, the switchable optical light source can be switched between:
operating in a first operational state in which the switchable optical light source functions as a Kerr frequency comb generator; and
operating in a second operational state in which the switchable optical light source functions as a Brillouin laser.

2. The switchable optical light source according to claim 1, wherein the first optical resonator and second optical resonator, would they be considered in isolation, both support a first resonance frequency and, optically coupled to each other, both support two split resonance frequencies corresponding to said first resonance frequency.

3. The switchable optical light source according to claim 2, wherein switching the switchable optical light source to the first operational state comprises:
changing the coupling factor and the frequency of the coherent light such that the first optical resonator and/or the second optical resonator support(s) a trio of equidistant resonance frequencies, including one of the two split resonance frequencies, and of which a middle resonance frequency is substantially equal to the frequency of the coherent light.

4. The switchable optical light source according to claim 3, wherein changing the coupling factor and the frequency of the coherent light comprises:
changing the coupling factor such that a distance between the higher of the two split resonance frequencies and a second resonance frequency is substantially equal to a distance between the second resonance frequency and a third resonance frequency, wherein the second and third resonance frequencies are either both lower or both higher than the two split resonance frequencies; and
changing the frequency of the coherent light to be substantially equal to the second resonance frequency.

5. The switchable optical light source according to claim 3, wherein changing the coupling factor and the frequency of the coherent light comprises:
changing the coupling factor such that a distance between the lower of the two split resonance frequencies, and a second resonance frequency, lower than the two split resonance frequencies, is substantially equal to a distance between the lower of the two split resonance frequencies and a third resonance frequency, higher than the two split resonance frequencies; and
changing the frequency of the coherent light to be substantially equal to the lower of the two split resonance frequencies.

6. The switchable optical light source according to claim 2, wherein switching the switchable optical light source to the first operational state comprises changing the coupling factor and the optical path length of at least one of the first optical resonator and second optical resonator, such that the first optical resonator and/or second optical resonator support(s) a trio of equidistant resonance frequencies, including one of the two split resonance frequencies, and of which a middle resonance frequency is substantially equal to the frequency of the coherent light.

7. The switchable optical light source according to claim 6, wherein changing the coupling factor and the optical path length of at least one of the first optical resonator and second optical resonator comprises:
changing the coupling factor such that a distance between the higher of the two split resonance frequencies and a second resonance frequency is substantially equal to a distance between the second resonance frequency and a third resonance frequency, wherein the second and third resonance frequencies are either both lower or both higher than the two split resonance frequencies; and
changing the optical path length of the first optical resonator and second optical resonator such that the second resonance frequency is substantially equal to the frequency of the coherent light.

8. The switchable optical light source according to claim 6, wherein changing the coupling factor and the optical path length of at least one of the first optical resonator and second optical resonator comprises:
changing the coupling factor such that a distance between the lower of the two split resonance frequencies, and a second resonance frequency, lower than the two split resonance frequencies, is substantially equal to a distance between the lower of the two split resonance frequencies and a third resonance frequency, higher than the two split resonance frequencies; and
changing the optical path length of the first optical resonator and second optical resonator such that the lower of the two split resonance frequencies is substantially equal to the frequency of the coherent light.

9. The switchable optical light source according to claim 2, wherein switching the switchable optical light source to the second operational state comprises:
changing the coupling factor such that a distance between the two split resonance frequencies is equal to a Stokes frequency shift; and
changing the frequency of the coherent light to be substantially equal to the higher of the two split resonance frequencies;
wherein the switching optionally comprises coupling further coherent light into the first optical resonator or the second optical resonator having a frequency equal to the lower of the two split resonance frequencies.

10. The switchable optical light source according to claim 2, wherein switching the switchable optical light source to the second operational state comprises:
changing the coupling factor such that a distance between the two split resonance frequencies is equal to a Stokes frequency shift; and
changing the optical path length of the first optical resonator and the second optical resonator such that the higher of the two split resonance frequencies is substantially equal to the frequency of the coherent light;
wherein the switching optionally comprises coupling further coherent light into the first optical resonator or the second optical resonator having a frequency equal to the lower of the two split resonance frequencies.

11. The switchable optical light source according to claim 1, the light switching unit further comprising a tuneable coupler, optically coupling the first optical resonator and the second optical resonator, and a controller configured to change said coupling factor by tuning the tuneable coupler.

12. The switchable optical light source according to claim 1, the light switching unit further comprising a first light guiding element that is configured to receive the coherent light, and that is optically coupled to the first optical resonator.

13. (canceled)

14. The switchable optical light source according to claim 12, the light switching unit further comprising a second light guiding element, optically coupled to the first or second optical resonator and configured to guide at least one of the generated Kerr-frequency comb or the generated Brillouin laser.

15. (canceled)

16. The switchable optical light source according to claim 13, wherein the first and second light guiding elements are the same light guiding element.

17. (canceled)

18. The switchable optical light source according to claim 1, wherein the first optical resonator and second optical resonator are integrated optical waveguides.

19. The switchable optical light source according to claim 16, wherein the first optical resonator and the second optical resonator are one of symmetric double stripe silicon nitride waveguides, chalcogenide waveguides, silicon oxynitride waveguides, Tellurite waveguides, and suspended silicon ridge waveguides, or wherein the first optical resonator and second optical resonator are optical ring resonators.

20. (canceled)

21. The switchable optical light source according to claim 16, the light switching unit further comprising a tuneable coupler, optically coupling the first optical resonator and the second optical resonator, and a controller configured to change said coupling factor by tuning the tuneable coupler, wherein the tuneable coupler is at least one of a pully coupler, a straight-directional coupler, or a multi-mode interferometer coupler, a MEMS activated coupler, a Mach-Zehnder coupling structure, or a directional coupler.

22. The switchable optical light source according to claim 1, wherein the first optical resonator and second optical resonator are whispering gallery mode resonators, or wherein the first optical resonator and second optical resonator are Fabry-Perot cavity resonators.

23. (canceled)

24. A light switching unit configured to receive coherent light from a coherent light source, wherein the light switching unit comprises a first optical resonator into which the coherent light is optically coupled, and a second optical resonator that is optically coupled to the first optical resonator;
wherein the first optical resonator and second optical resonator are both Kerr active and Brillouin active;
wherein the light switching unit is configured to be switched between operating in a first operational state in which the light switching unit outputs a Kerr frequency comb, and a second operational state in which the light switching unit outputs Brillouin laser light, by changing:
the coupling factor corresponding to the optical coupling between the first optical resonator and second optical resonator; and
at least one of (A) an optical path length of at least one of the first optical resonator and second optical resonator, and (B) a frequency of the coherent light.

25. The switchable optical light source according to claim 16, wherein the first light guiding element is a waveguide.
